(19) United States
(12) Patent Application Publication
(10) Pub. No.: US 2004/0079169 A1
(43) Pub. Date: Apr. 29, 2004

(54) Plant injection method and apparatus

(75) Inventors: Peter M. Wild, Winchester, MA (US); David E. Floyd, Marlborough, MA (US); Joseph J. Doccola, Kingtown, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Peter M. Wild, Winchester, MA (US)

(21) Appl. No.: 10/611,405

(22) Filed: Jul. 1, 2003

Related U.S. Application Data
(60) Provisional application No. 60/393,992, filed on Jul. 3, 2002.
(60) Provisional application No. 60/433,064, filed on Dec. 12, 2002.

(51) Int. Cl. G01F 1/00

(52) U.S. Cl. 73/861

(57) ABSTRACT

The present invention relates to methods for injecting desired amounts of fluids into plants, in particular embodiments, woody plants, e.g., trees and woody vines. A metering device is provided which dynamically measures an amount of fluid that is injected into the plant. A system and method are also provided for creating a pressurized reservoir of injectable fluid in the plant to assist in the injection of the fluid. A pressure release valve is also provided to prevent overpressurization of the pressurized reservoir of injectable fluid. In one embodiment, fluid is returned to a metering device of an injection system when the pressure within the pressurized reservoir exceeds a predetermined amount of pressure. A pressure gauge is also provided that measures pressure within the plant. A falling pressure indicates that fluid is being injected into the plant. Manual and battery-powered plant injection devices are also provided.

### RELATED APPLICATIONS

This application claims the benefit of U.S. Provisional Application No. 60/393,992, filed on Jul. 3, 2002, and Ser. No. 60/433,064, filed on Dec. 12, 2002. The entire teachings of the above applications are incorporated herein by reference.

### BACKGROUND OF THE INVENTION

Injection treatment of plants is a method of introducing an agent into a plant. The agent can be introduced into the plant by gravity or under pressure, and a wide variety of devices exists for injecting plants.

Injection treatment is useful for the treatment of disease conditions or insect infestation, such as Dutch Elm Disease, American Chestnut Blight, Woolly Adelgid, Red Palm Weevil, etc. Fungicides, insecticides, and chemicals can be administered by injection.

Nutritional supplements can also be administered by injection to maintain, improve, or enhance the health of the plant. Such administration can also be an effective form of prevention of disease and insect attack, since many diseases and insects attack plants that are in suboptimal health or are otherwise stressed.

Many plants are quite valuable, especially in the case of slow-growing plants, such as trees or woody vines (e.g., grapevines). A tree can take many years to grow to maturity, and it is therefore desirable to maintain adult trees in a healthy state, given the cost and inconvenience of removal and replacement of trees. Likewise, some woody plants, such as grapevines and fruit trees, are valuable because of their crop value, and the time required to bring a replacement plant to maturity is time during which the plant is not producing income.

### SUMMARY OF THE INVENTION

In general, in administration of agents to plants, for many reasons it is desirable to quickly and easily determine the amount of agent that is being administered to each plant. For example, many of the medicaments and nutrients are expensive and any waste of the fluid is thus preferably avoided. Also, too much of the agent may be toxic and kill or substantially destroy the plant. It is therefore desirable to provide an injection device that is easy to use to inject a predetermined amount of agent into a plant.

Therefore, a need exists for an apparatus and method for treating a plant that overcomes at least some of the aforementioned problems.

The present invention relates to methods for injecting desired amounts of fluids into plants, in particular embodiments, woody plants, e.g., trees and woody vines. A metering device is provided which dynamically measures an amount of fluid that is actually injected into the plant. The metering device is easy to use and does not require substantial operator skill. A system and method are also provided for creating a pressurized reservoir of injectable fluid in the plant to assist in the injection of the fluid. A pressure release valve is also provided to prevent overpressurization of the pressurized reservoir of injectable fluid. In one embodiment, fluid is returned to a metering device of an injection system when the pressure within the pressurized reservoir exceeds a predetermined amount of pressure. A pressure gauge is also provided that measures pressure within the plant. A falling pressure indicates that fluid is being injected into the plant. Manual and battery-powered plant injection devices are also provided in accordance with alternative embodiments of the present invention.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention. All parts and percentages are by weight unless otherwise indicated.

FIG. 1 is a cross-sectional view of a plant injection device of an embodiment of the invention.

FIG. 2 is a perspective view of the metering device shown in FIG. 1.

FIG. 3 is a cross-sectional view of a plug used to inject fluid into a plant in accordance with an embodiment of the invention.

FIG. 4 is a side view of a drill bit used to create a bore in a plant in accordance with an embodiment of the invention.

FIG. 5 is a sectional view of an insertion tool used to insert the plug of FIG. 3 into a plant.

FIG. 6 is a top, cross-sectional view of plugs used in accordance with embodiments of the invention used to create pressurized reservoirs in a plant.

FIG. 7 is a side view of a plug having internal components defined by phantom lines used to create one or more pressurized reservoirs in plants in accordance with alternative embodiments of the invention.

FIG. 8 is an exploded view of the plug shown in FIG. 7.

FIG. 9 is a bottom view of the plug shown in FIG. 7.

FIG. 10 is a cross-sectional view of a plug used to create one or more pressurized reservoirs in a plant in accordance with alternative embodiments of the invention.

FIG. 11 is a perspective exploded view of a pressure gauge in accordance with one embodiment of the invention.

FIG. 12 is a cross-sectional view of the pressure gauge shown in FIG. 11.

FIG. 13 is a perspective view of a manually-actuated plant injection device in accordance with further embodiments of the invention.

FIG. 14 is a cross-sectional view of a pressure relief valve for use with plant injection systems.

FIG. 15 is a side view of a battery-powered plant injection device in accordance with yet another embodiment of the invention.

FIG. 16 is a perspective view of an embodiment of an injection needle assembly.

FIG. 17 is a perspective view of another embodiment of an injection needle assembly.

### DETAILED DESCRIPTION OF THE INVENTION

A description of various embodiments of the invention follows.

The invention features methods and injection devices for injecting a fluid into plants, especially woody plants, e.g., trees, shrubs, vines.

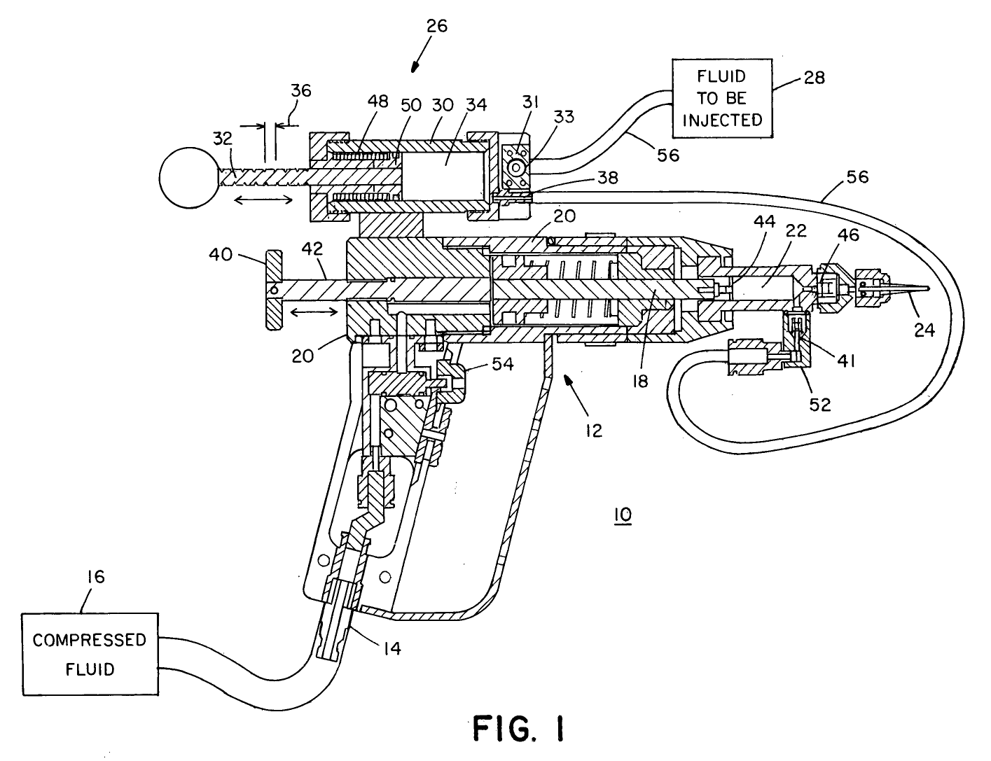

With reference to FIG. 1, a fluid injection system, designated generally by reference numeral 10, is provided for injecting a fluid, such as a medicament, nutrient, fertilizer, pesticide, fungicide, growth regulator, hormone, or other fluid, into a plant, for example, a woody plant. An injection device 12 includes an input port 14 that can be coupled to a source of compressed fluid 16, such as carbon dioxide, nitrogen, air, or other suitable liquid or gas. The compressed fluid 16 is used to actuate a piston 18 which is movable within the body 20 to inject fluid within chamber 22 into a plant via injection needle 24. An exemplary input pressure range by the source of compressed fluid 16 at input port 14 is between about 2,600 and 13,000 mm of mercury (50 and 250 psi). In one embodiment, the source of compressed fluid 16 has an initial pressure of about 155,000 mm of mercury (3,000 psi).

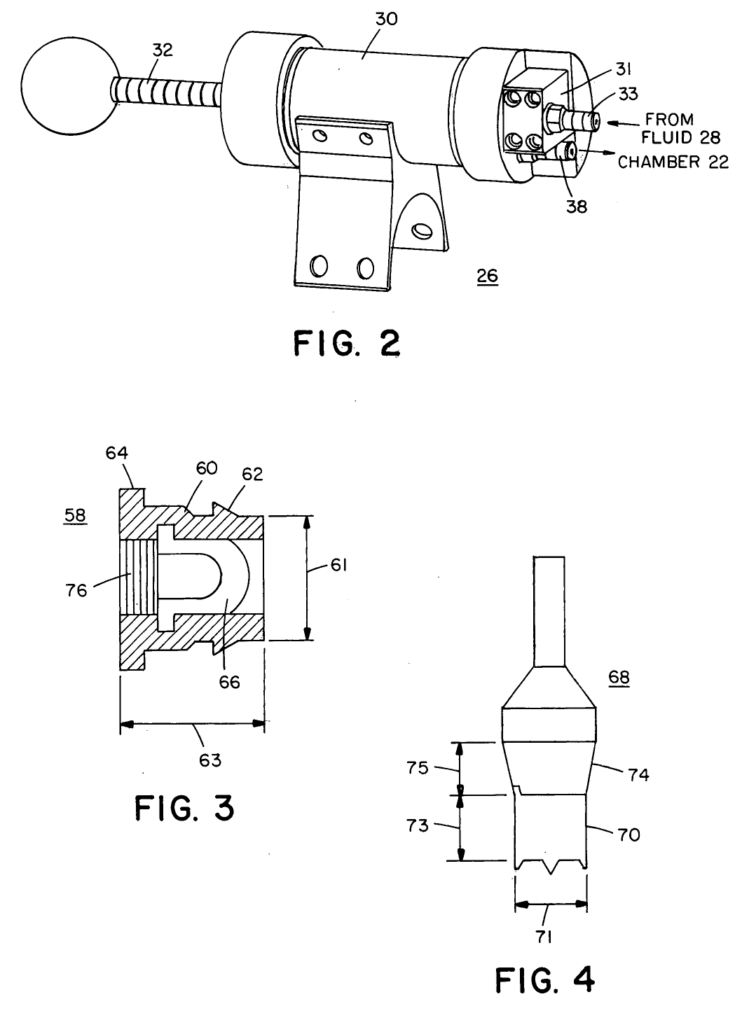

The injection device 10 can include a device to accurately and easily measure the amount of fluid that is actually injected into the plant. Until now, the injection industry has had to rely on a “best guess” to determine the amount of fluid actually delivered to a plant. FIGS. 1 and 2 illustrate one embodiment of a dose-sizer or metering device 26 that is used to monitor the amount of fluid injected into a plant.

In this particular embodiment, the metering device 26 is coupled between the source of fluid to be injected 28 and the chamber 22. A plunger-type device 30 is first used to meter a desired amount of fluid from the source 28. A graduated pull rod 32 is pulled by the operator to draw a desired amount of fluid from the source 28. A one-way check valve 31 at input port 33 allows one-way flow of the fluid into the chamber 34 of device 26. The pull rod 32 in this embodiment is graduated in one mL increments 36 such that the operator can draw a desired amount of fluid from the fluid source 28. In this embodiment, chamber 34 has a volumetric capacity of about 10 mL, although other capacities can be used. The 10 mL volumetric capacity in this embodiment has been selected as a desired typical injection amount in a single injection site. The operator can inject more than 10 mL of fluid into a single injection site when high volume applications are required. Additionally, 10 mL is an easy number to remember and add while injecting. For example, if a plant is to be injected with 35 mL of fluid, the operator injects the entire capacity of the device 26 three times and one-half the capacity thereafter. For illustrative purposes only, a small tree usually requires an injection amount of about 20-45 mL of fluid while a big tree usually requires about 70-80 mL.

An outlet port 38 of the metering device 26 is couplable to the injection device 12. A one-way check valve 41 is provided to allow one-way flow of the fluid into the chamber 22. One or more by-pass valves can be provided at any point along each of the lines 56, for example, in case the metering device 28 should break.

In this embodiment, chamber 22 has a variable volumetric capacity between about 1.5 mL to 3.0 mL, although other volumetric capacities can be used. More particularly, wheel 40 can be turned by the operator to cause shaft 42, which is threadedly engaged with body 20, to travel in a direction parallel to its longitudinal axis to move piston 18. Since piston 18 is coupled to plunger head 44, the total volumetric capacity of chamber 22 is changed by turning wheel 40. Other volumetric capacities of chamber 22 can be used to suit the specific job requirements, for example, if more than 3.0 mL is desired to be injected into a plant with a single pull of the trigger.

The injection device 10 is designed to minimize and preferably eliminate the likelihood of cross-contaminating plants during injection. This is accomplished in one aspect of the invention by providing a positive pressure on one-way check valve 46 to prevent any fluid from being drawn into the needle 24 after injection. In a particular embodiment, a minimum pressure of about 2,600 mm of mercury (50 psi) is maintained on check valve 46.

In operation, the operator draws a desired amount of fluid into metering device 26. As spring 48 forces the plunger head 50 to the right in FIG. 1, the fluid is prevented from going back toward fluid source 28 by check valve 31 and thus is supplied to input port 52 of the injection device 12. The fluid passes around check valve 41 and fills chamber 22 in preparation for injection. Again, the volumetric capacity of chamber 22 can be changed by the operator by turning wheel 40.

As the operator squeezes the trigger 54, compressed fluid supplied by source 16 forces piston 18 to the right thereby forcing the fluid in chamber 22 around check valve 46 and through needle 24 and thus into the plant. The amount of fluid actually injected into the plant is dynamically measured as the pull rod 32 is moved to the right after each injection. When the fluid is not injected into the plant when the operator pulls the trigger, the pull rod 32 does not move, thus alerting the operator that the fluid still needs to be injected into the plant.

During typical injection of a plant, the operator pulls the pull rod 32 to draw about 10 mL of fluid into the metering device 26 and injects the entire quantity into the plant at one or more injection sites while visually verifying that the fluid is actually being injected into the plant. The operator repeats this as many times as needed to fulfill the job requirements. If less than 10 mL is required, or a fluid quantity that is not a multiple of 10, for example, 25 mL, the operator pulls the graduated pull rod 32 the desired amount by counting the increments 36.

In alternative embodiments, the metering device 26 can be mechanically or externally powered. For example, the device 26 can be electronically or pump actuated. In other embodiments, the metering device 26 can mechanically indicate the amount of fluid that has been delivered to the plant. For example, a totalizer, such as a gas pump, can be used in accordance with the invention. Alternatively, the total amount delivered to the plant can be electronically indicated.

The fluid can be manually or automatically placed into a separate holding chamber, such as chamber 34, for dispensing by the injection device 12. In yet other embodiments, fluid can be dispensed directly by the injection device 12 through an electronic or mechanical metering device, for example, via spring, pump-applied pressure, or vacuum.

In alternative embodiments, a system and method are proposed for providing a volume injection pressure-enhanced reservoir. More specifically, a reservoir of the fluid that is to be injected into a plant is created within the plant, for example, the xylem of a tree. By providing such a pressurized reservoir at an injection site, approximately 2 to 30 times the amount of fluid can be injected at an injection site as opposed to not having the pressurized reservoir at the injection site. Thus, fewer injection sites are needed per plant.

With reference to FIGS. 3-6, a system is provided for creating a pressurized reservoir of fluid within the plant to assist in the injection of the fluid. As shown in cross-section in FIG. 3, a plug 58 includes a body 60 that is shaped to be permanently inserted into the plant. In this embodiment, an outwardly extending curved ridge or barb 62 is used to snugly secure the plug 58 into the plant when inserted into a bore 59. The body 60 defines an aperture therethrough and terminates in a flange 64 at one end in the embodiment shown. The body 60 can be tapered traversing its length. In a particular embodiment, the body 60 has a diameter 61 in the range of between about 5.5549 and 14.2875 mm (0.2187 and 0.5625 inches) in this embodiment. The body 60 has a length 63 between about 9.525 and 15.875 mm (0.375 and 0.625 inches) in this embodiment. The body 60 can include brass, copper, aluminum, plastic, or other suitable materials.

A membrane 66, which includes a section through which an injection needle can pass, is disposed within the body 60. For example, the membrane can have a prepierced section through which the needle 24 can pass, but creates a fluid seal when the needle is withdrawn. In this embodiment, the membrane 66 is curved such that when the pressurized reservoir is formed (to the right of the membrane in FIG. 3), the pressure helps push the membrane toward the body walls 60 to help secure the membrane therein. The membrane 66 can be formed from a rubber or other suitable materials.

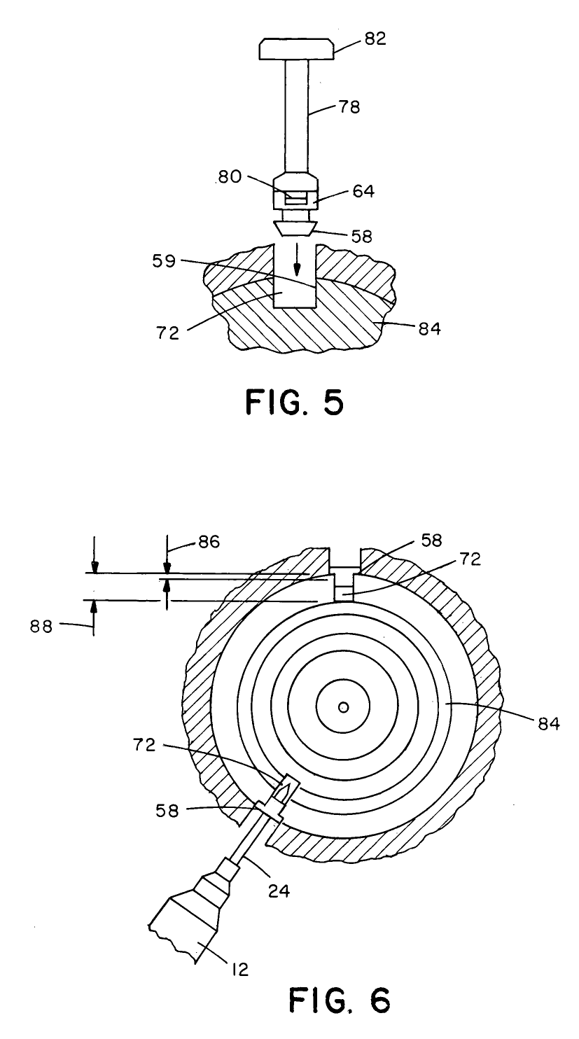

A drill bit 68 is provided in FIG. 4 that includes a section 70 that bores out the reservoir space 72 (see FIGS. 5 and 6). The bit 68 can also include a tapered section 74 that countersinks the plant. Section 70 can have a diameter 71 of between about 5.555 and 14.2875 mm (0.2187 and 0.5625 inches) in particular embodiments. Section 70 can have a length 73 in the range of between about 15.875 and 19.05 mm (0.625 and 0.75 inches) in various embodiments. The tapered section 74 can have a length 75 in the range of between about 9.525 and 15.875 mm (0.375 and 0.625 inches) in alternative embodiments.

The plug 58 can be threaded 76 at one end to threadedly engage an insertion tool 78 having a male threaded portion 80 (FIG. 5). Thus, after the boring has been completed, the insertion tool 78 can be threaded into the plug 58. The plug 58 can be forced into the bore 59 in an interference-fit arrangement so the plug is permanently secured within the xylem 84. A mallet or hammer can be used to hit strikeable-member 82 of the tool 78 to force the plug 58 into position such that, in a particular embodiment, the flange 64 is countersunk 86 into the xylem 84 between about 4.7625 and 6.35 mm (0.1875 and 0.25 inches). The plug 58 remains in the plant and does not need to be removed. The depth 88 of the bore 59 is typically less than one inch, and in particular embodiments, can have a depth in the range of between about 15.875 and 19.05 mm (0.625 and 0.75 inches).

As also shown in FIG. 6, an injection device 12 having a needle 24 passes through membrane 66 and injects the fluid into the reservoir 72 to create a pressurized reservoir that forces the fluid into the plant. In this embodiment, the injection device 12 delivers the fluid into the reservoir 72 at about 1,034 to 1,551 mm of mercury (20 to 30 psi). A step-down regulator can be coupled to the injection gun 12 to provide a desired pressure range.

In accordance with aspects of this system, a number of advantages are realized. Each injection site having the pressurized reservoir increases the consistency of the injection window during the growing season wherein the fluid may be injected into the plant. By providing a pressurized reservoir at each injection site, each injection site is viable and thus unnecessary holes are beneficially avoided. Additionally, the reservoir remains pressurized after withdrawal of the needle for at least a short time to continue to inject fluid into the plant. If the plug is not present, the injection fluid exits the injection site upon withdrawal of the needle without injecting all of the fluid. The metering device provides the operator with an approximate amount of fluid that has actually been injected into the plant. In a particular embodiment, an injection rate of about 1-5 mL per caliper inch per minute can be achieved. In alternative embodiments, an injection rate of between 1-50 mL per injection site per minute can be achieved.

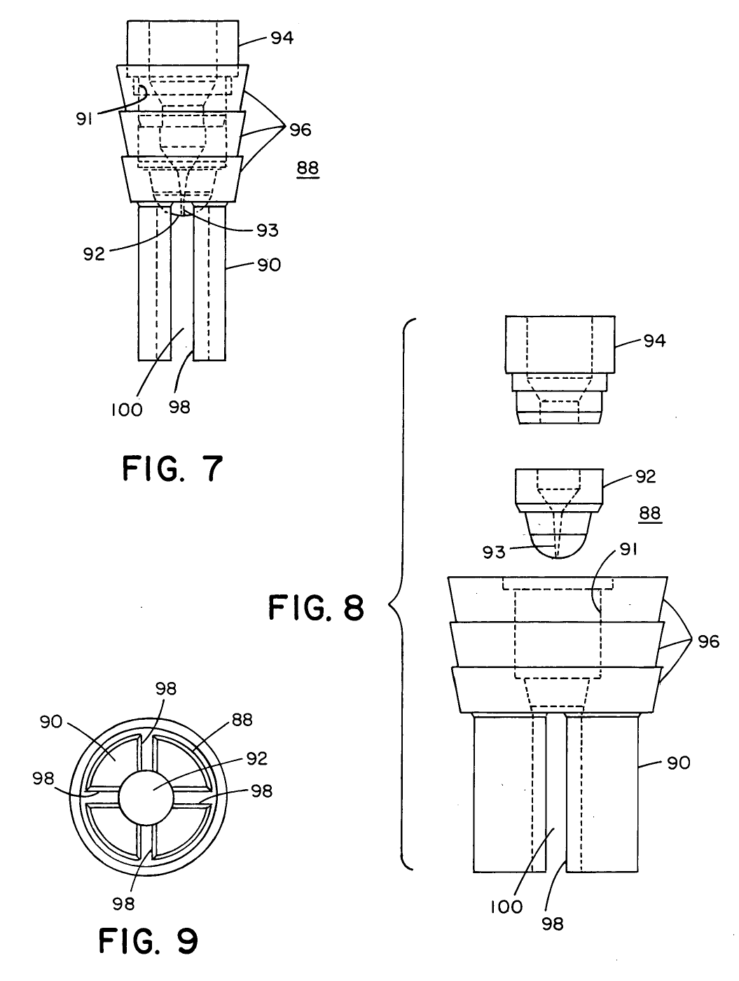

FIGS. 7-9 illustrate an alternative embodiment of a plug 88 used to assist in the injection of fluid into a plant. In this embodiment, a body 90 includes a central bore 91 into which a pierceable membrane or septum 92 is positioned. An insertable member 94 is positioned within at least a portion of the bore 91 to secure the membrane 92 therein. The member 94 can be ultrasonically welded or otherwise coupled to the body 90.

In one embodiment, the membrane 92 is provided with a pre-pierced section 93 such that a blunt injection needle can be inserted therethrough. This obviates the use of sharper and potentially more dangerous needles.

The body 90 is shaped, in a particular embodiment, to be permanently inserted into a bore in a plant such as a tree. In this embodiment, a plurality of ridges or circumferential barbs 96 are provided in the body 90 to secure the plug 88 within the bore in the plant. The barbs 96 engage the xylem of the tree.

The body 90 can also include one or more slots or openings 98 extending along a longitudinal axis of the body. These openings 98 allow the injection fluid provided within the central cavity 100 formed by the body 90 to be delivered to the plant. That is, the slots 98 allow the fluid injected through the membrane 92 to be delivered and thus absorbed by the plant. In alternative embodiments, a plurality of holes or openings can be provided in addition to, or separate from, slots 98.

The plug 88 is left in the plant after injection, which prevents bugs or other insects from infesting the injection site. In a tree, for example, the bark grows over the plug 88 and the inoculation site thus disappears. The plug 88 can be used for diffuse porous and trachea resin-based trees.

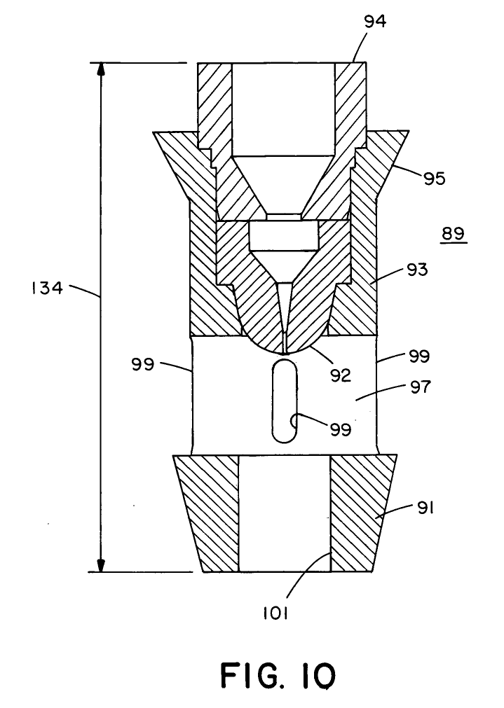

FIG. 10 illustrates another embodiment of a tree plug 89 used to inject fluid into a plant. In this embodiment, the plug 89 can be used for ring porous trees that need access to the first three growth rings to facilitate a low-pressure injection. The bottom circumferential ring or barb 91 is used to hold the body 93 within the plant, and upper circumferential ring or barb 95 can be used to seal injection fluid within the bore of the plant. An insertable member 94 maintains pierceable membrane 92 within the body 93. The injection fluid is injected through membrane 92 and into cavity 97 formed by body 93. One or more apertures 99 in body 93 allows the injection fluid to be injected into the plant. An aperture 101 in lower ring 91 can further be provided to allow fluid injection into the plant. In a particular embodiment, the plug 89 has a length 134 of about 19.05 mm (0.75 inches) and is used in applications requiring less than about 15,514 mm of mercury (300 psi) in the pressurized reservoir.

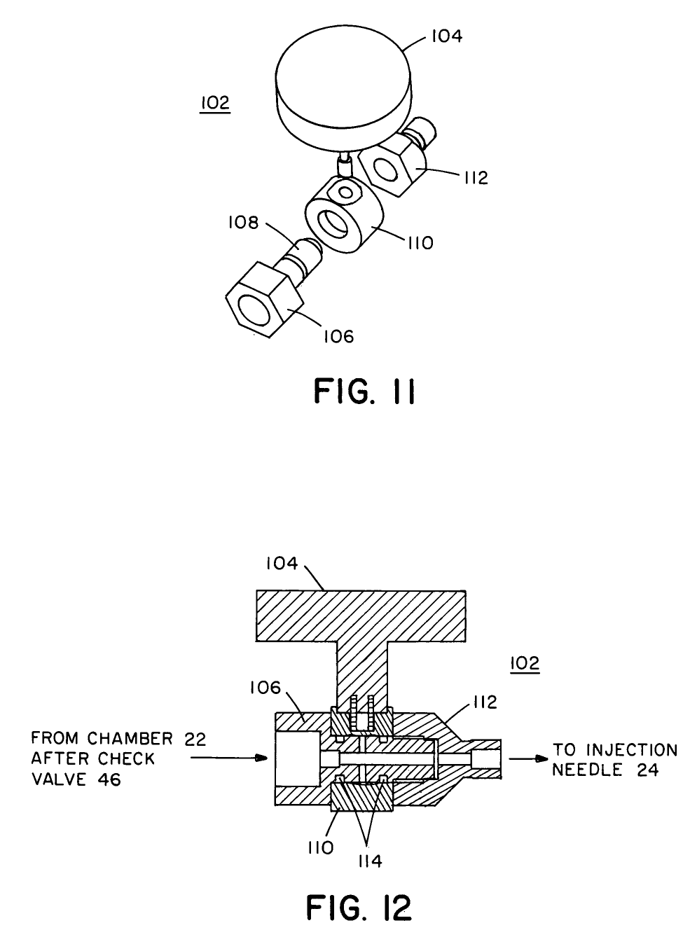

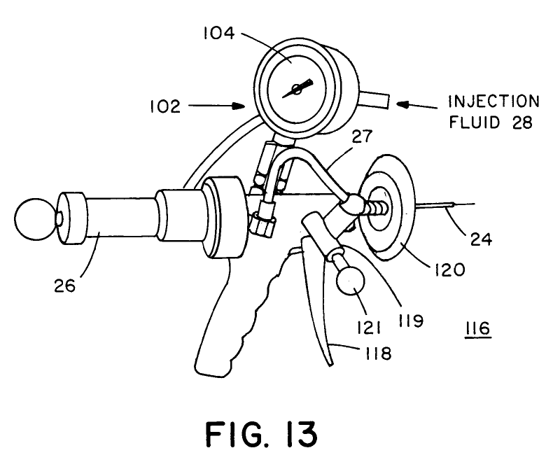

FIGS. 11 and 12 illustrate a pressure gauge 102 that can be included with the fluid injection system 10. In this embodiment, the pressure gauge 102 is configured to measure pressure within a pressurized fluid reservoir 72 within the plant.

The gauge 102 is provided after check valve 46 such that the readout 104 indicates the pressure within the fluid reservoir tree via injection needle 24. Thus, when the pressure indicated by the readout 104 begins to drop during the injection process, it is known that the injection fluid is actually being injected or absorbed by the plant. Because uptake at each injection site can vary, the feedback provided by the pressure gauge 102 and the metering device 26 shows any differential in uptake. The slower uptake occurs with increasing pressure on the plant side, thereby increasing injection time. Typically, very low pressures are recorded while the fluid reservoir fills. As the micro-injection process continues, there is an increase in reservoir 72 pressure without any change in pressure regulation of the device 10. A maximum pressure is reached with a pull of the device trigger 54. When the reservoir pressure drops, which is observed as a downward sweep in the gauge needle or readout device 104, this is an indication to the operator to release the trigger to complete the application.

The actual pressures recorded vary according to, for example, plant anatomy (i.e., ring porous, diffuse porous, or nonporous trees), environmental factors, and product formulation. Typically, ease of injection is noted with 20,700 mm of mercury (400 psi) or less in the reservoir 72. The injection device 10 is capable of delivering pressures three to eight times these pressures, although such pressures are typically not needed to inject the fluid into the plant.

Thus, the tip pressure gauge 102 is a feedback and teaching tool to the operator. Reading the maximum pressure and waiting for the downward sweep, the operator is provided with feedback on rate of injection fluid uptake into the plant. Thus, when the pressure is falling, the piston 18 is at the end of its stroke.

The pressure gauge 102 in a particular embodiment can include a first member 106 having a circular periphery 108 upon which a rotatable member 110 is mounted. The readout device 104 is mounted to the rotatable member 110. A second member 112 is mounted to the first member 106. A pair of O-rings 114 seal the fluid within the gauge 102. Thus, the readout device 104 can be rotated about the injection device 10 during use for the convenience of the operator.

FIG. 13 illustrates an alternative embodiment of an injection device 116 used to inject fluid 28 into a plant. In this embodiment, the device 116 is manually actuated, i.e., the operator squeezes the handle 118 which causes injection of the fluid into the plant. Thus, there is no need for a compressed fluid 16 or power source to cause injection of the fluid 28. In a particular embodiment, about 0.5 mL of fluid 28 is injected per handle pull. A spray guard 120 can be provided to prevent injection fluid 28 from spraying toward the operator. A metering device 26 and pressure gauge 102 as described above can be provided to monitor the uptake of fluid into the plant.

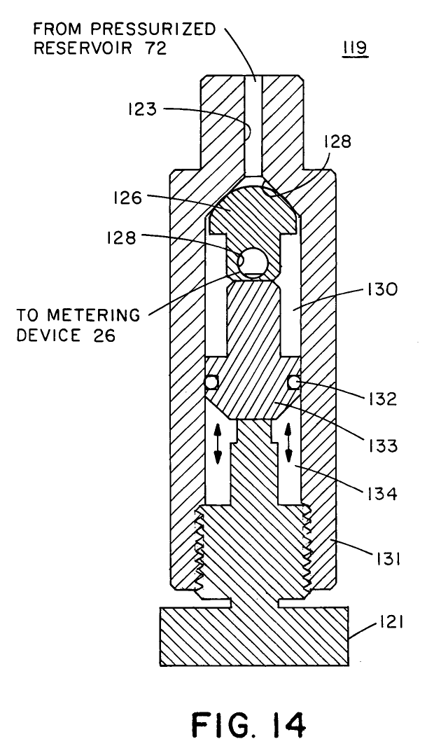

A pressure release valve 119 (shown in cross-sectional view in FIG. 14) can be provided with any of the embodiments disclosed in this application to prevent overpressurization in the pressurized reservoir 72 within the plant. Because these devices 12, 116, and 122 can provide significant pressures, e.g., up to about 724,000 mm of mercury (14,000 psi), this valve 119 allows fluid in the reservoir 72 to return to the metering device 26 via hose 27 thereby reducing the pressure in the high pressure reservoir.

As shown in FIG. 14, an inlet 123 is coupled to the pressurized reservoir 72. A check valve 126 is pushed against surface 128 to controllably allow injection fluid around the check valve and back into the metering device 26 or fluid source 28 via aperture 128 in the body. A spring provided in space 130 provides the biasing force to prevent injection fluid from going around check valve 126 until there is a minimum injection pressure in the pressurized reservoir 72. The biasing force is adjustable by rotating knob 121 which moves spring stop 133 by threadedly engaging body 131 of the pressure relief valve 119. A sealing member 132, such as an O-ring, prevents injection fluid from reaching area 134. In specific embodiments, the pressure relief valve can be used with injection pressures of up to about 31,000 mm of mercury (600 psi).

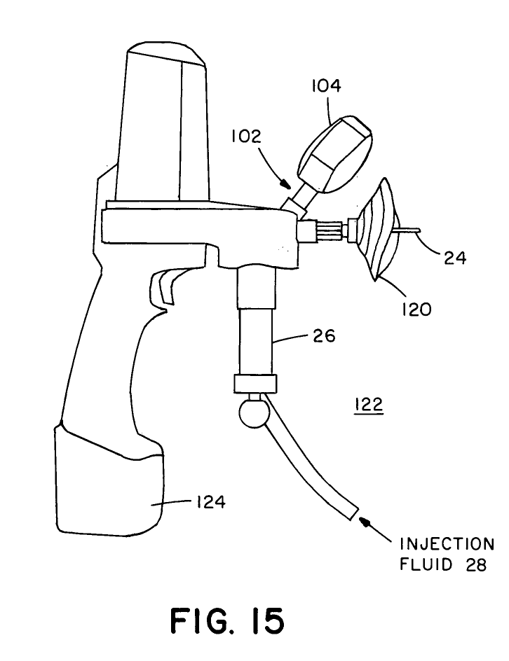

FIG. 15 illustrates another embodiment of an injection device 122 used to inject fluid 28 into a plant. In this embodiment, the device 122 is powered by a battery 124 and uses an electric piston pump to inject the fluid 28. In a particular embodiment, about 0.5 mL of fluid 28 is injected per piston stroke. A spray guard 120, pressure gauge 102, pressure release valve 119, and metering device 26 can also be provided.

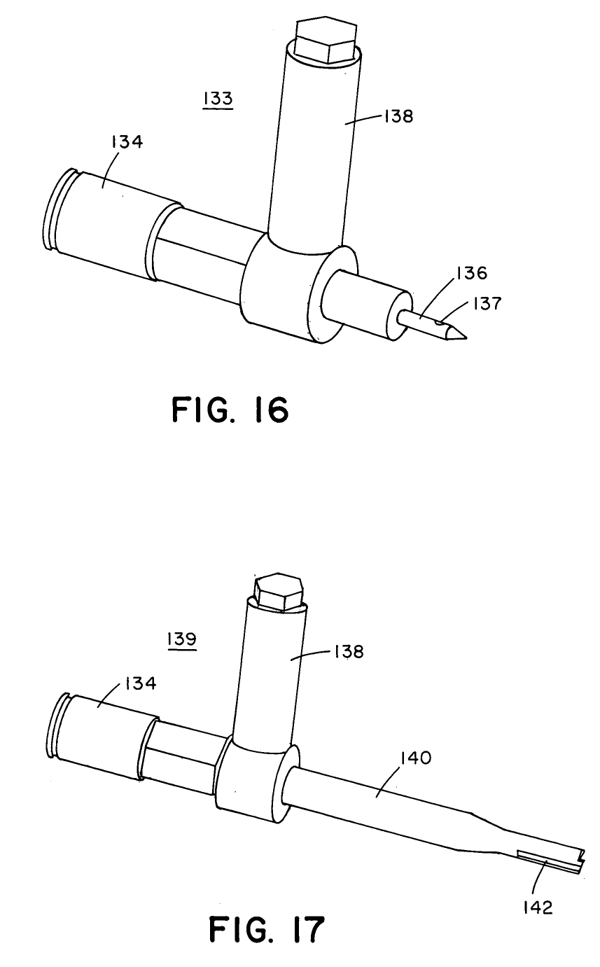

FIG. 16 illustrates an embodiment of an injection needle assembly 133 that is connectable to an injection device 10. A quick-connect coupler 134 can be used to connect the assembly 133 to the injection device 10. The injection needle 136 can be suitably dimensioned so as to be able to inject fluid 28 into skinny plants. In a particular embodiment, the needle 136 has an aperture 137 as disclosed in U.S. application Ser. No. 10/434,407, and has a length of less than about 1.6 centimeters. A flexible tube can be used in any of the embodiments to connect the injection needle to the injection device 10. This allows the user some flexibility in positioning himself/herself during injection of the fluid 28. In a particular embodiment, a tube about three feet long is connectable between the injection needle and injection device. A handle 138 can be provided on the assembly 133 to facilitate insertion and removal of the injection needle 136 into/from the plant being injected.

FIG. 17 illustrates another embodiment of an injection needle assembly 139 that includes an injection needle 140 having a slot 142 at the distal end for allowing the fluid 28 to be rapidly injected into the plant.

Any of the injection devices disclosed herein can be used to deliver fluid 28 to a plant in an ultra-low volume (ULV) or high volume delivery amount. Typically, the ULV requires a jet-injection needle, which is inserted in the plant during the injection process. A plug inserted into a bore in a plant to create the pressurized reservoir is used during the high volume delivery.

The methods and systems disclosed in U.S. patent applications Ser. No. 09/902,494, filed Jul. 10, 2001, and Ser. No. 10/434,407, filed May 8, 2003, can be used to accordance with the present invention. The entire teachings of the above applications are incorporated herein by reference.

While this invention has been particularly shown and described with references to various embodiments thereof, it will be understood by those skilled in the art that various changes in form and details may be made therein without departing from the scope of the invention encompassed by the appended claims.

What is claimed is:

1. A metering device for use with a power-operated injection system for dynamically measuring an amount of fluid that is injected into a plant.

2. The metering device of claim 1, wherein the metering device limits a total amount of fluid that is injected into one or more injection sites of the plant.

3. The metering device of claim 1, wherein the metering device includes a plunger having a graduated pull rod.

4. The metering device of claim 1, wherein the metering device is externally powered and/or pump-actuated.

5. The metering device of claim 1, wherein the metering device manually, mechanically, and/or electronically indicates the total amount of fluid injected into the plant.

6. The metering device of claim 1, wherein the metering device includes a chamber for containing the fluid, the chamber being separate from a fluid reservoir containing a supply of the fluid.

7. The metering device of claim 1, wherein the metering device employs a spring, a pump, applied pressure, and/or vacuum.

8. The metering device of claim 1, wherein the metering device includes a totalizer.

9. A power-operated fluid injection system for injecting injection fluid into a plant, comprising:
an injection device adapted to be coupled to a fluid under pressure for assisting in the injection of the injection fluid into the plant; and
a metering device for dynamically measuring an amount of injection fluid that is injected into the plant.

10. The injection system of claim 9, further comprising a pressure release valve that allows fluid to return to the metering device when pressure within a pressurized reservoir within the plant exceeds a predetermined pressure.

11. The injection system of claim 9, further comprising a pressure gauge that measures an injection pressure within the plant.

12. The injection system of claim 9, further comprising an injection needle couplable to the injection device by a tube.

13. A method for injecting a fluid into a plant with a power-operated injection system, comprising dynamically measuring, with a metering device, an amount of fluid that is injected into a plant.

14. A method for injecting a fluid into a plant comprising:
providing a bore in the plant;
inserting a plug into the bore; and
injecting the fluid through a membrane of the plug to provide a pressurized reservoir within the plant for injecting the fluid into the plant.

15. The method of claim 14, further comprising automatically preventing overpressurization of the pressurized reservoir.

16. The method of claim 14, further comprising dynamically measuring an amount of fluid that has been injected into the plant.

17. A plug for use in the injection of a fluid into a plant, the plug comprising a body having a membrane disposed therein through which a needle is passed to inject the fluid into the plant, the plug being positionable in a bore of the plant to help provide a pressurized reservoir in the plant.

18. The plug according to claim 17, wherein the body is shaped to be permanently inserted into the bore of the plant.

19. The plug according to claim 17, further comprising a barb for securing the plug in the bore of the plant and a barb for sealing the fluid in the bore of the plant.

20. A system for injecting a fluid into a plant, comprising:
an injection device couplable to a fluid under pressure for assisting in the injection of the fluid into the plant, the injection device also couplable to a reservoir of the fluid to be injected into the plant;
a needle attachable to the injection device for allowing the fluid to be injected to pass therethrough; and
a plug configured to be permanently inserted into a bore of the plant, the plug including a membrane through which the needle passes, for providing a pressurized reservoir of the fluid in the plant.

21. The system of claim 20, further comprising a drill bit shaped to form at least a portion of the reservoir boundary in the plant and countersink the bore.

22. A plug for use in the injection of fluid into a plant comprising a body having a bore therethrough, a membrane positionable within at least a portion of the bore, and an insertable member positionable within at least a portion of the bore for maintaining the membrane within the at least a portion of the bore.

23. The plug of claim 22, wherein the body includes at least one outwardly extending ridge.

24. A pressure gauge that measures an injection pressure within a plant, a falling injection pressure measured by the pressure gauge indicating that a fluid is being injected into the plant.

25. The pressure gauge of claim 24, wherein the injection pressure within the plant is a pressure within a reservoir of the fluid within the plant.

26. An apparatus for injecting a fluid into a plant, the apparatus comprising:
(a) a fluid reservoir containing the fluid;
(b) a gas reservoir containing a gas;
(c) a needle for injecting the fluid into the plant;
(d) an injection device couplable to the fluid reservoir, the gas reservoir, and the needle, the injection device using the gas to inject the fluid through the needle and into the plant; and
(e) a pressure gauge that dynamically indicates that fluid is being injected into the plant.

27. A hand-operated apparatus for injecting fluid into a plant, comprising:
(a) a fluid reservoir containing the fluid;
(b) a needle for injecting the fluid into the plant; and
(c) an injection device couplable to the fluid reservoir and the needle, the injection device including a handle that, when manually depressed by the operator, causes injection of the fluid into the plant.

28. The hand-operated apparatus of claim 27, further comprising a pressure release valve for preventing overpressurization in a pressurized reservoir within the plant.

29. The hand-operated apparatus of claim 27, further comprising a metering device that dynamically measures an amount of fluid that is injected into the plant.

30. A battery-powered apparatus for injecting fluid into a plant, comprising:
(a) a fluid reservoir containing the fluid;
(b) a needle for injecting the fluid into the plant;
(c) an injection device couplable to the fluid reservoir and the needle; and
(d) an injection device powered by a battery connectable thereto to inject the fluid into the plant.

31. The battery-powered apparatus of claim 30, further comprising a pressure relief valve for preventing overpressurization in a pressurized reservoir within the plant.

32. The battery-powered apparatus of claim 30, further comprising a metering device that dynamically measures an amount of fluid that is injected into the plant.

33. The battery-powered apparatus of claim 30, further comprising a pressure gauge that measures an injection pressure within the plant, a falling pressure indicating that the fluid is being injected into the plant.

34. A pressure release valve for use with an apparatus for injecting a fluid into a plant.

35. The pressure release valve of claim 34, wherein the apparatus includes a hand-held plant injection device.

36. The pressure release valve of claim 34, wherein the pressure relief valve is adjustable to control a maximum pressure of the fluid in the plant.

37. An apparatus for injecting a fluid into a plant, comprising:
(a) a fluid reservoir containing the fluid;
(b) a needle for injecting the fluid into the plant;
(c) an injection device couplable to the fluid reservoir and the needle, the injection device injecting the fluid through the needle and into a pressurized reservoir within the plant; and
(d) a pressure release valve for preventing overpressurization within the pressurized reservoir.

38. The apparatus of claim 37, further comprising a metering device for dynamically measuring an amount of fluid that is injected into the plant.

39. The apparatus of claim 38, wherein the pressure release valve allows fluid in the pressurized reservoir to return to the metering device.

40. An injection needle assembly including a quick-connect coupler for attaching the injection needle assembly to an injection device for injecting fluid into a plant.

41. The assembly of claim 40, further comprising a handle for inserting and removing a needle of the assembly into/from the plant.

42. The assembly of claim 40, wherein the assembly includes an injection needle, the needle including a slot at a distal end thereof.
